(19) United States
(12) Patent Application Publication
(10) Pub. No.: US 2008/0298613 A1
(43) Pub. Date: Dec. 4, 2008

(54) Wireless headset with mic-side driver cut-off

(76) Inventors: Milan Slamka, Camas, WA (US); Todd Yuzuriha, Vancouver, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/357,441

(22) Filed: Feb. 17, 2006

Related U.S. Application Data
(60) Provisional application No. 60/654,430, filed on Feb. 18, 2005.

(51) Int. Cl. H04R 5/02; G06F 17/00

(52) U.S. Cl. 381/311; 700/94

(57) ABSTRACT

A wireless headset has a pair of earpieces, each with a speaker or driver, and a microphone that is supported by one of the earpieces. The headset operates in wireless communication with an audio source, such as a personal audio player, and a mobile telephone. The wireless headset provides automatic cut-off of the driver in the earpiece supporting the microphone whenever the microphone is activated, thereby to prevent feedback between the microphone and the driver in the supporting earpiece.

### TECHNICAL FIELD

The present invention relates to wireless headsets and, in particular, to a wireless headset with automatic cut-off of a speaker/driver adjacent a microphone whenever the microphone is activated.

### BACKGROUND AND SUMMARY OF THE INVENTION

Wireless headsets are becoming increasingly popular for use with mobile telephones and with digital audio sources, such as Ipod® audio players, personal digital assistants (PDAs), USB dongles connected to personal computers, etc. Typically, wireless headsets for use with mobile telephones are distinct from those for use with digital audio sources, because the former require a microphone and the latter do not.

A headset microphone is typically positioned on a boom that extends from an earpiece. For mobile telephones, such a boom is an accepted and necessary encumbrance for bi-directional telephonic communication. For digital audio sources, which are commonly used to playback music, a headset boom is superfluous. Hence, wireless headsets for use with mobile telephones are typically distinct from those for use with digital audio sources.

In accordance with the present invention, a wireless headset has a microphone positioned on a stub boom or in an earpiece of the headset. The stub boom is characterized as having a length that is about the same as the size of an earpiece of the headset. A stub boom extending from an earpiece, or a microphone in an earpiece, provides only compact spacing of a microphone from the driver (i.e., speaker) in the supporting earpiece. The compact spacing can lead to audio feedback with associated loud noises at the driver, which is very disturbing for the user and undesirable.

Accordingly, the present invention provides automatic cut-off of the driver in an earpiece supporting a microphone when the microphone is activated, thereby to prevent feedback through that microphone-side driver. For example, an incoming telephone call on a mobile telephone may be indicated at the headset while a user is listening to an audio source. Upon the user answering the call, the headset establishes wireless communication with the mobile telephone, activates the microphone, and automatically deactivates the driver (i.e., speaker) located in earpiece that supports the microphone.

The audio signal for the telephone communication is not delivered to the driver in the earpiece supporting or containing the microphone, thereby to prevent audio feedback. Audio feedback can otherwise arise in a headset having a microphone in close proximity to an active driver. The automatic driver cut-off of the present invention allows the wireless headset to have a microphone on a stub boom, or no boom at all, so as to be acceptable for use with both digital audio sources and mobile telephones.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a diagrammatic side view of a wireless headset as worn by a user.

FIG. 2 is an elevation view of a first embodiment of a wireless headset with compact spacing between a microphone and one earpiece.

FIG. 3 is a block diagram of headset.

FIG. 4 is a flow diagram of a microphone automatic cut-off method according to an aspect of the present invention.

FIG. 5 is an elevation view of a second embodiment of a wireless headset with compact spacing between a microphone and one earpiece.

### DETAILED DESCRIPTION OF THE INVENTION

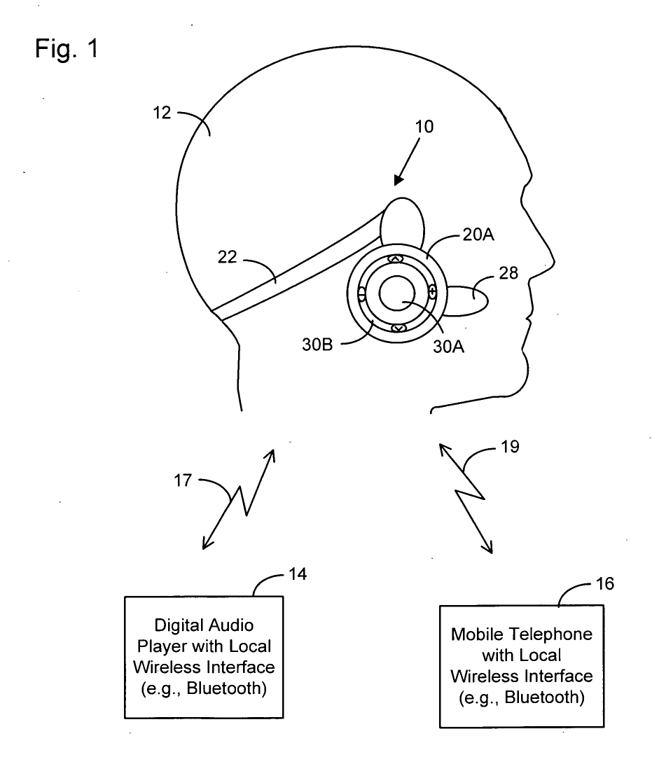

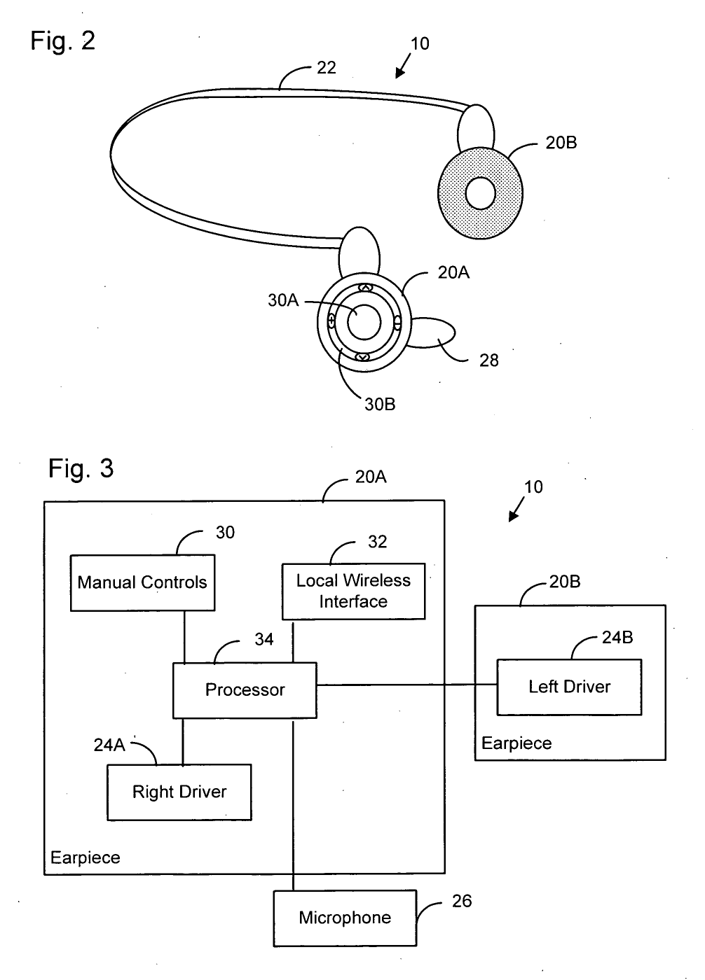

FIG. 1 is a diagrammatic side view of a wireless headset 10 worn by a user 12. FIG. 2 is an elevation view of wireless headset 10. FIG. 3 is a block diagram of headset 10. The following description refers generally to FIGS. 1-3.

FIG. 1 illustrates wireless headset 10 as being in simultaneous wireless communication with a digital audio player 14 and with a mobile (e.g., cellular) telephone 16. Digital audio player 14 and mobile telephone 16 each include a local wireless interface, such as a Bluetooth standard interface, a WiFi standard interface (IEEE 802.11), or any other local wireless interface.

For example, digital audio player 14 may be an Ipod® audio player, a personal digital assistant (PDA), a USB dongle connected to a personal computer, etc. In one implementation, digital audio player 14 communicates with headset 10 over an audio playback link 17 such as a one-directional Asynchronous Connectionless (ACL) link employing low-complexity, subband codec (SBC) encoding in which audio is sampled at 48 KHz, 16 bits/sample and compressed, as is known in the art. In this sample implementation, mobile telephone 16 communicates with headset 10 with a telephone communication link 19, such as a bi-directional synchronous connection-oriented (SCO) with Continuous Variable Slope Delta Modulation (CVSD) encoding that carries an 8 kHz, 8-bit data stream.

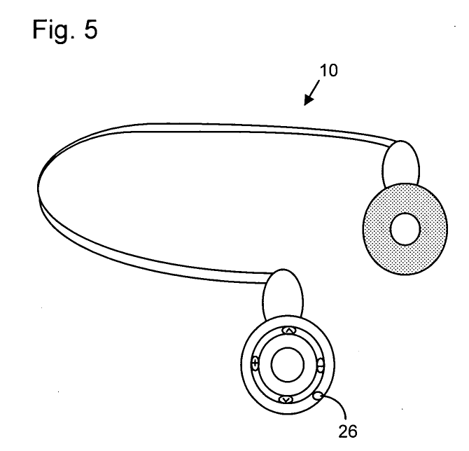

Wireless headset 10 includes a pair of earpieces 20A and 20B (only 20A shown in FIG. 1) connected together by a headband 22, which could alternatively be a neckband or a simple wire coupling. Earpieces 20A and 20B include respective speakers or drivers 24A and 24B. In addition, earpiece 20A includes a microphone 26, which may be located on a stub boom 28 (FIG. 2) or within earpiece 20A (FIG. 5). Stub boom 28 is characterized as having a length generally no more than the maximum dimension of earpiece 20A. It will be appreciated that many conventional microphone booms on headsets are significantly longer than the dimension of an earpiece.

Earpiece 20A also includes one or more user-operable controls 30, such as a central main control button 30A that can cycle through one or more operational controls, and a rocker switch 30B with opposed vertical rocker controls and opposed horizontal rocker controls. Earpiece 20A also contains a local wireless (e.g., Bluetooth) interface 32 and a processor 34. Local wireless interface 32 provides local wireless communication with audio sources, such as audio player 14 and mobile telephone 16, and processor 34 processes control inputs received at controls 30 and signals received from or delivered to interface 32.

In one implementation, for example, user manipulation of main control button 30A can instruct processor 34 to turn wireless headset 10 on and off and, if depressed for a predetermined time period, to synchronize with one or more available local wireless sources, such as digital audio player 14 and mobile telephone 16. In this exemplary implementation, vertical rocker controls and horizontal rocker controls of rocker switch 30B may instruct processor 34 to change audio volume and audio source selection (e.g., channel), respectively. It will be appreciated that headset 10 may include a wide variety of alternative user-operable controls and that controls 30 are merely one exemplary implementation.

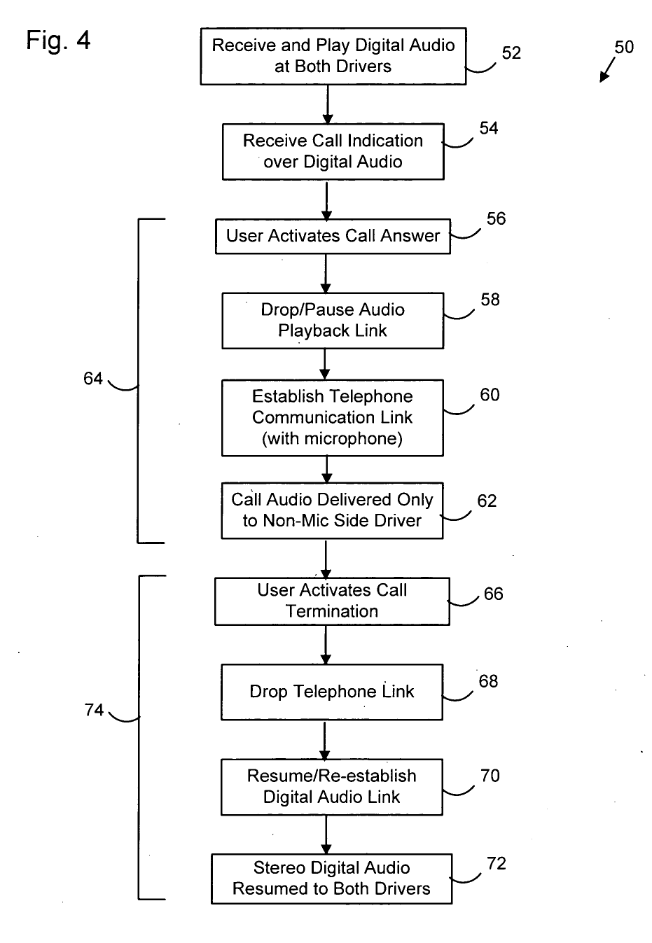

FIG. 4 is a flow diagram of an automatic driver cut-off method 50 according to an aspect of the present invention. Automatic cut-off method 50 may be implemented as processor instructions (e.g., software) stored with or encoded into and executed by processor 34.

In step 52, headset 10 receives and plays digital audio signal at both drivers 24A and 24B. For example, the stereo digital audio is received from digital audio player 14.

In step 54, headset 10 receives and plays a call indication (e.g., a ring tone, a beep, etc.) over the digital audio signal. The call indication may be played at one or both of drivers 24A and 24B and indicates an in-coming call on mobile telephone 16.

In step 56, the user activates a call answer control to answer the call. For example, the call answer control may be made by the user manually activating (e.g., pressing) main control button 30A or by the user activating some other control device.

In step 58, the audio playback link 17 with digital audio player 14 is paused or dropped.

In step 60, the telephone communication link 19 with mobile telephone 16 is established, including a link with microphone 26.

In step 62, the telephone call audio signal is delivered only to driver 24B in earpiece 20B. The telephone call audio signal is not delivered to driver 24A in earpiece 20A supporting microphone 26. Microphone may be positioned inside earpiece 20A, on a stub boom extending from earpiece 20A, or even on a standard-length boom. The effect is to automatically cut-off audio at driver 24A.

The telephone call audio signal is not delivered to driver 24A in earpiece 20A to prevent audio feedback between driver 24A and microphone 26. Audio feedback can otherwise arise in a headset 10 having a microphone 26 in close proximity to a driver 24A, particularly if microphone 26 is located on a stub boom 28 having a length of about the size or the earpiece 20A (FIGS. 1 and 3) or co-located in earpiece 20A (FIG. 5). Such close proximity may be referred to as compact spacing of microphone 26 from its supporting earpiece 20A.

Steps 56-62 represent a call answering operation 64 during stereo audio playback and allow headset 10 with compact microphone spacing to switch from dual-sided (e.g., stereo) audio playback to one-sided telephone audio automatically upon a user answering or making a call over link 19 on mobile telephone 16. Such switching is integrated into the call answer control step so that the user is never subjected to the audio feedback that could arise between a microphone 26 and a driver 24A in close proximity to each other.

Although described with reference to answering a telephone call, it will be appreciated that such automatic cut-off of the microphone-side driver could similarly be applied when initiating a telephone call. It will be appreciated, therefore, that headset 10 can employ compact microphone spacing that accommodates both audio stereo playback and mobile telephone communication without being subject to the audio feedback that can arise when a microphone and driver are close to each other.

Following steps 66-72 represent a call termination operation 74 that ends a telephone communication and resumes the stereo audio playback.

In step 66, the user activates a call termination control to terminate the call (i.e., hang-up). For example, the call termination control may be made by the user manually activating (e.g., pressing) main control button 30A.

In step 68, the telephone communication link 19 with mobile telephone 19 is dropped.

In step 70, the audio playback link 17 with digital audio player 14 is resumed or re-established.

In step 72, headset 10 receives and plays stereo digital audio at both drivers 24A and 24B.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a wireless headset having first and second earpieces with respective first and second drivers, and a microphone, and being in wireless communication with an audio source and a mobile telephone, the microphone being supported by the first earpiece, an automatic driver cut-off method, comprising:
playing playback audio received from the audio source on the first and second drivers;
activating a telephone communication on the mobile telephone through the headset;
upon activating the telephone communication, stopping the playing of the playback audio at the first and second drivers and delivering audio received from the telephone communication only to the second driver and not to the first driver.

2. The method of claim 1 in which activating the telephone communication includes answering a telephone call in response to receiving a call indication.

3. The method of claim 1 in which activating the telephone communication includes initiating a telephone call.

4. The method of claim 1 in which stopping the playing of the playback audio includes stopping the wireless communication between the audio source and the wireless headset.

5. The method of claim 1 in which the microphone is contained within the first earpiece.

6. The method of claim 1 in which microphone is contained within a boom supported by the first earpiece.

7. The method of claim 6 in which the boom is a stub boom.

8. A wireless headset, comprising:
first and second earpieces with respective first and second drivers;
a microphone supported by the first earpiece;
a local wireless communication interface for communicating with an audio source and a mobile telephone, the audio source providing playback audio to the wireless headset and the mobile telephone providing telephone communication to and from the wireless headset; and
a processor with processor-readable storage that stores processor instructions for delivering audio only to the second driver and not to the first driver during telephone communication and otherwise delivering audio to both the first driver and the second driver.

9. The wireless headset of claim 8 in which the processor-readable storage stores processor instructions for playing playback audio received from the audio source on the first and second drivers, upon activation of a telephone communication, stopping the playing of playback audio received from the audio source on the first and second drivers and delivering audio only to the second driver and not to the first driver.

10. The wireless headset of claim 9 in which activating the telephone communication includes answering a telephone call in response to receiving a call indication.

11. The wireless headset of claim 9 in which activating the telephone communication includes initiating a telephone call.

12. The wireless headset of claim 9 in which stopping the playing of the playback audio includes stopping the wireless communication between the audio source and the wireless headset.

13. The wireless headset of claim 8 in which the microphone is contained within the first earpiece.

14. The wireless headset of claim 8 in which microphone is contained within a boom supported by the first earpiece.

15. The wireless headset of claim 14 in which the boom is a stub boom.

16. A wireless headset, comprising:
first and second earpieces with respective first and second drivers;
a microphone supported by the first earpiece;
a local wireless communication interface for communicating with an audio source and a communication source, the audio source providing playback audio to the wireless headset and the communication source providing bidirectional communication to and from the wireless headset; and
a processor with processor-readable storage that stores processor instructions for delivering audio only to the second driver and not to the first driver during the bidirectional communication and otherwise delivering audio to both the first driver and the second driver.

17. The wireless headset of claim 16 in which the processor-readable storage stores processor instructions for playing playback audio received from the audio source on the first and second drivers, upon activation of a bidirectional communication, stopping the playing of playback audio received from the audio source on the first and second drivers and delivering audio only to the second driver and not to the first driver.

18. The wireless headset of claim 16 in which the microphone is contained within the first earpiece.

19. The wireless headset of claim 16 in which microphone is contained within a stub boom supported by the first earpiece.
